(19) United States
(12) Patent Application Publication
(10) Pub. No.: US 2016/0144954 A1
(43) Pub. Date: May 26, 2016

(54) UNMANNED AERIAL VEHICLE

(71) Applicant: Skymetro UAV Technology Inc., Monton (CA)

(72) Inventor: Gilles Daigle, Monton (CA)

(21) Appl. No.: 14/942,469

(22) Filed: Nov. 16, 2015

Related U.S. Application Data
(60) Provisional application No. 62/084,845, filed on Nov. 26, 2014.

(51) Int. Cl. B64C 27/08; B64C 39/02; B64C 25/02

(52) U.S. Cl. CPC B64C 27/08; B64C 25/02; B64C 39/024; B64C 2201/00

(57) ABSTRACT

Herein is disclosed an unmanned aerial vehicle having motor arm holders configured such that when inserted into its corresponding arm holder on the central hub or holder, the motor arm holders are tilted at an angle between 6 to 10 degrees angle upwards. This drops the entire machine relative to the central hub making the UAV unit more “bottom heavy”, thus creating a pendulum effect, which is more stable in flight.

### FIELD

The present disclosure relates to unmanned aerial vehicles with improved lift and stability characteristics.

### BACKGROUND

Most unmanned aerial vehicles (UAVs) having a small multirotor design have flat or straight out motor arms attached to a center plate, in the range of 200 mm to 400 mm in length. This design causes stress on the bottom mounting plate when carrying loads, often rendering the structural strength weak, and most times touchy on the controls.

### SUMMARY

The present disclosure provides motor arm holders configured such that when inserted into its corresponding arm holder on the central hub or holder, the motor arm holders are tilted at an angle between 6 to 10 degrees angle upwards. This drops the entire machine relative to the central hub making the UAV unit more “bottom heavy”, thus creating a pendulum effect, which is more stable in flight.

An embodiment disclosed herein includes an unmanned aerial vehicle, comprising:

a) a landing gear including a support platform having opposed sides and a pair of landing gear legs descending from each of said opposed sides;

b) a housing and a support hub located therein;

c) a selected number of motor support arm holders evenly distributed about a periphery of said support hub;

d) each of said selected number of motor support arm holders having a proximal end portion of a corresponding motor support arm locked therein, said motor support arm holders being configured to lock the proximal end portion of the motor support arm such that the each motor support arm is inclined upwardly from horizontal by an angle in a range from about 6 to 10 degrees;

e) each motor support arm having a distal end and having a motor holder affixed thereto, and each motor holder having a propeller motor locked therein and each propeller motor having a propeller attached thereto;

f) an electronic control circuit array mounted on top of said top center plate;

g) a quick release utility plate releasably attached to, and spaced below, said bottom center plate, said quick release utility plate configured to releasably receive instrumentation for transportation by the unmanned aerial vehicle, said quick release utility plate being attached to said support platform;

h) said housing including a top canopy for enclosing and covering said electronic control circuit array and said hub which is releasably secured to said support platform; and

i) a space between said quick release utility plate and said bottom center plate configured to be a battery compartment and to receive therein one or two batteries electrically connected to said propeller motors and said electronic circuit array.

The support hub may include a top center plate and bottom center plate spaced apart and bolted together, and wherein said selected number of motor support arm holders evenly distributed about a periphery of said support hub are sandwiched between, and secured to, said top center plate and said bottom center plate.

Each motor support arm may be inclined upwardly from horizontal by an angle of about 8 degrees.

The motor support arms may be hollow having a hollow interior, and the motor holders may include a port located below said propeller motor which is aligned with the hollow interior of the motor support arm so that air from propeller wash is forced through the port down the hollow interior into an interior of the support hub. The motor support arms may be positioned to direct the air towards the electronic circuit array for air cooling the electronic circuit array.

The motor holder may include a stabilizer fin extending below a bottom of the motor holder. This stabilizer fin may be generally triangular in shape and positioned on the bottom of the propeller motor holder so that air from the propeller wash is forced past said stabilizer fin thereby acting to aid in stabilizing the unmanned aerial vehicle in flight.

In an embodiment, the battery compartment may be configured to receive one battery inserted from a side of the unmanned aerial vehicle with the one rectangular battery being centered in the battery compartment.

In another embodiment the battery compartment may configured to receive two batteries inserted from a front of the unmanned aerial vehicle with the two batteries being centered in the battery compartment.

The selected number of motor arm support holders may be any one of four, (4), six (6), and eight (8), and including a corresponding number of support arms mounted symmetrically around the hub.

The motor support arm holders may include a two (2) piece clamp including two (2) clamp sections, which upon being assembled together, between the top center plate and the bottom center plate, has an interior to receive therein the proximal end of the motor support arm, and upon being bolted together locks the motor support arm in place.

The motor support arm holders and associated motor support arms clamped therein may include a locking mechanism configured to prevent rotation of the motor support arm with respect to the motor support arm holder.

In one embodiment this locking mechanism may include a stud located on an inner surface of at least one of the clamp sections, and the proximal end of said motor support arm clamped between said two clamp sections including a hole having a size sufficiently large to receive the stud therein.

In another embodiment this locking mechanism may include a stud located on the proximal end of the motor support arm and one of the two clamp sections including a hole having a size sufficiently large to receive the stud therein.

In an embodiment each motor holder may include a two (2) piece clamp including two (2) clamp sections, which upon being assembled together, has an interior to receive therein the distal end of the motor support arm, and upon being bolted together locks the motor holder to the motor arm. A top clamp section of the two clamp sections may include a receptacle to receive therein the propeller motor, and a bottom clamp section of the two clamp sections may include a stabilizer fin integrally formed therewith on a bottom surface of the bottom clamp section. In this embodiment the motor holder and associated distal end of the motor support arm clamped therein may include a locking mechanism configured to prevent rotation of the motor holder with respect to the motor support arm. In an embodiment this locking mechanism may include a stud located on an inner surface of at least one of the clamp sections, and the distal end of the motor support arm clamped between the two clamp sections includes a hole having a size sufficiently large to receive the stud therein. In another embodiment this locking mechanism may include a stud located on the distal end of the motor support arm and one of the two clamp sections includes a hole having a size sufficiently large to receive the stud therein.

In an embodiment the motor arm holders and the motor support arms may be configured such that each motor support arm is moveable in the motor arm holder between at least two positions and can be locked in each position to provide at least two pre-set lengths of the motor support arm with respect to the hub. In this embodiment the motor arm holders may include a two (2) piece clamp may include two (2) clamp sections, which upon being assembled together, has an interior to receive therein the proximal end of the motor support arm, and upon being bolted together locks the motor arm in place.

In an alternative embodiment the motor arm holders and associated motor support arms clamped therein may include a locking mechanism configured to lock the motor support arms in the at least two positions with respect to the motor support arm holders, and to prevent rotation of the motor support arm with respect to the motor support arm holder when locked in each of the at least two positions. This locking mechanism may include a stud located on an inner surface of at least one of the clamp sections, and the proximal end of the motor support arm clamped between the two clamp sections including at least two holes spaced apart having a size sufficiently large to receive said stud therein, and wherein in at least a first of the at least two positions the stud is inserted through a first hole of two holes, and in a second of the at least two positions the stud is inserted through a second hole of the two holes. The locking mechanism may include at least two spaced studs located on the proximal end of the motor support arm and one of the two clamp sections including hole having a size sufficiently large to receive each stud therein.

The unmanned aerial vehicle may be configured such that the distal end of the motor support arms are above a top surface of the canopy such that in the event the unmanned aerial vehicle is inverted upside down on the ground it rests on the propellers and not the top surface of the canopy thereby providing protection for the electronic array.

The selected number of motor arm support holders may be six (6), and including six (6) corresponding support arms mounted symmetrically around the hub.

The support platform may include a support plate mounted on spaced beams oriented at about 90 degrees to a planar surface of the support plate, each end of each of the spaced beams have a hole extending therethrough, and including O-rings mounted in the holes, and including a first and second tubes mounted on the support platform at opposed sides thereof with the tubes extending through corresponding ends of the spaced beams such that the support plate is slidable back and forth towards the front and back of the support platform such that when a load is attached to the support plate its center of gravity can be adjusted.

The quick release universal adapter plate may include a pair of spaced holes located at side edges of the utility plate, and wherein the support platform includes a pair of spaced plates located on the side edges of the support platform each having two spaced holes extending therethrough in registration with corresponding holes in the quick release utility plate which are used to attach the universal adapter plate to the support platform.

There is disclosed herein an unmanned aerial vehicle kit, comprising:

a) a landing gear including a support platform having opposed sides and a pair of landing gear legs descending from each of said opposed sides;

b) four (4), six (6) and eight (8) motor support arms;

c) support hubs for each of said four (4), six (6) and eight (8) motor support arms, each support hub including support arm holders evenly distributed about a periphery of said support hub;

d) each of said motor support arm holders having a proximal end portion of a corresponding motor support arm locked therein, said motor support arm holders being configured to lock the proximal end portion of the motor support arm such that the each motor support arm is inclined upwardly from horizontal by an angle in a range from about 6 to 10 degrees;

e) each motor support arm having a distal end and having a motor holder affixed thereto, and each motor holder having a propeller motor locked therein and each propeller motor having a propeller attached thereto;

f) an electronic control circuit array mounted on top of said top center plate;

g) a quick release universal plate releasably attached to, and spaced below, said bottom center plate, said quick release utility plate configured to releasably receive instrumentation for transportation by the unmanned aerial vehicle, said quick release universal plate being attached to said support platform;

h) a housing including a top canopy for enclosing and covering said electronic control circuit array and said hubs which is releasably secured to said support platform; and

i) a space between said quick release utility plate and said bottom center plate configured to be a battery compartment and to receive therein one or two batteries electrically connected to said propeller motors and said electronic circuit array.

A further understanding of the functional and advantageous aspects of the present disclosure can be realized by reference to the following detailed description and drawings.

### BRIEF DESCRIPTION OF THE DRAWINGS

Embodiments disclosed herein will be more fully understood from the following detailed description thereof taken in connection with the accompanying drawings, which form a part of this application, and in which:

FIG. 1 is a perspective view of the UAV constructed in accordance with the present disclosure;

FIG. 2a is an exploded view of the UAV of FIG. 1;

FIG. 2b is a perspective view of one half of a motor mount arm clamp for clamping the motor mount arms to the central hub of the UAV;

FIG. 3 is a perspective view of a motor arm support assembly attachable to a distal end of a motor arm in which a propeller motor is seated when the UAV is assembled;

FIG. 4 is a perspective view of a motor arm used to connect the motor arm support assembly to the body of the UAV;

FIG. 5 is a perspective view of support brackets used to attach the universal adaptor plate to the central hub of the UAV to produce a volume that becomes the battery compartment;

FIG. 6 is a bottom perspective view of a motor arm support hub and motor arms and propellers assembled;

FIG. 7 is a perspective view of the support and landing gear section of the present UAV;

FIG. 8a is a side elevation view of the assembled UAV taken from one side;

FIG. 8b is a front elevation view of the assembled UAV taken from the front of the UAV;

FIG. 8c is a top view looking down of the assembled UAV;

FIG. 9a is a front view of the UAV showing two batteries inserted into the battery compartment; and

FIG. 9b is as a side view of the UAV showing one battery inserted into the battery compartment.

### DETAILED DESCRIPTION

Various embodiments and aspects of the disclosure will be described with reference to details discussed below. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

As used herein, the terms “comprises” and “comprising” are to be construed as being inclusive and open ended, and not exclusive. Specifically, when used in the specification and claims, the terms “comprises” and “comprising” and variations thereof mean the specified features, steps or components are included. These terms are not to be interpreted to exclude the presence of other features, steps or components.

As used herein, the term “exemplary” means “serving as an example, instance, or illustration,” and should not be construed as preferred or advantageous over other configurations disclosed herein.

As used herein, the terms “about” and “approximately” are meant to cover variations that may exist in the upper and lower limits of the ranges of values, such as variations in properties, parameters, and dimensions.

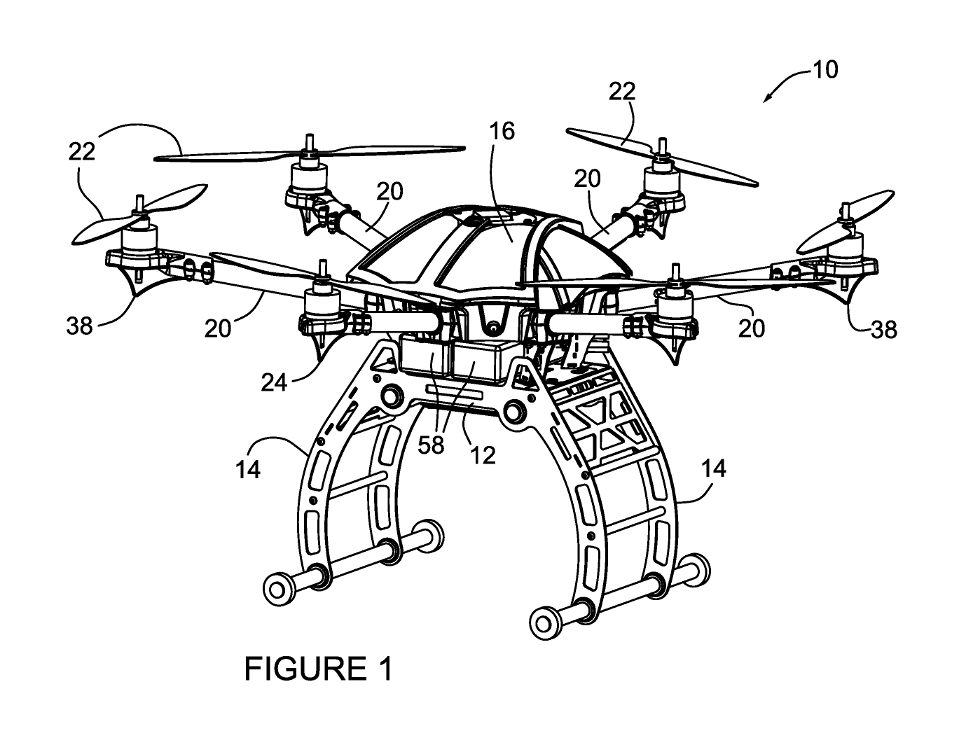

FIG. 1 shows a perspective view of a UAV shown generally at 10. UAV 10 includes a structural support assembly which includes a support platform 12 which supports the other components making up the UAV. The structural support assembly further includes two curved support assemblies 14 (or landing gear) projecting down from opposed sides of support platform 12.

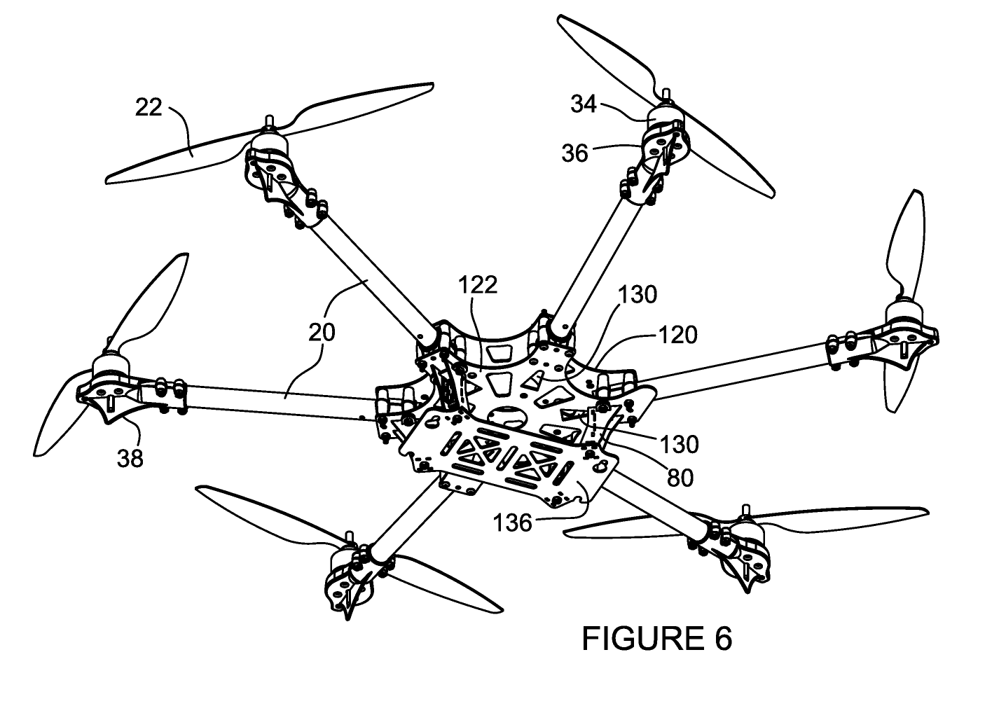

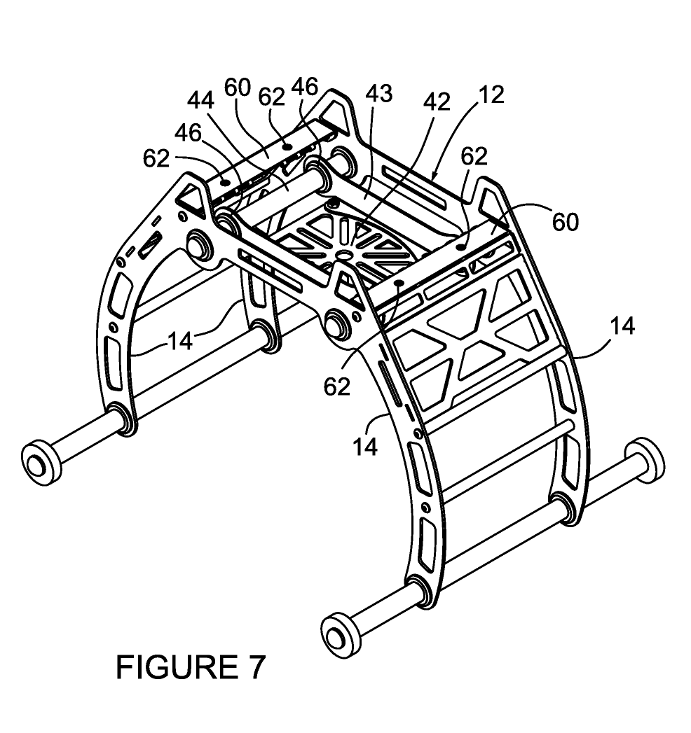

FIG. 7 shows a perspective view of the support platform 12 and landing gear section 14 of the present UAV 10. Support platform 12 includes a slotted support plate 42 mounted on two plates 43 which are bent 90 degrees to support plate 42. The ends of plates 43 have holes extending there through that incorporate rubber “O” rings thereby forming sliding rubber bushings 46. Support platform 12 includes a pair of spaced removable tubes 44 with one tube 44 extending through the two bushings 46 on one side of support plate 42 and the other tube 44 extending through the two bushings 46 on one side of support plate 42. Bushings 46 are very advantageous in that they act to lessen vibration and to allow support plate 42 to slide back and forth on tubes 44, so when equipment is bolted on support plate 42, the user/operator can slide the attached equipment back and forth to balance the center of gravity of UAV 10. As can be seen in FIG. 7, support plate 42 is not centered on tubes 44 but rather is positioned closer to the front side of the landing gear 14. Thus, this configuration of support platform 12 allows the user/operator to center the center of gravity depending on the shape of the structure mounted on support plate 42. Plates 60 located on the side edges of support 12 have two spaced holes 62 extending there through which are used to attach a universal adapter plate 136 (shown in FIG. 6) to support structure 12 to be discussed hereinafter.

Mounted on support platform 12 is utility housing 16. Six (6) motor support arms 20 extend outwardly from housing 16 and mounted on the distal ends of motor support arms 20 are propeller motors 34. Propellers 22 are each coupled to propeller motors 34 which in turn is seated in a two piece motor holder 36. The lower portion of the two piece motor holder 36 has a small triangular fin 38 just below the motor area. This fin 38 serves as a stabilizer on the “yaw” axis (rotation of the unit left or right). This fin 38 is very advantageous when the UAV is in wind conditions in that it helps to maintaining the UAV 10 pointing in the right direction as much as possible. The propeller wash forcing air downwards re-enforces the effect of these fins 38.

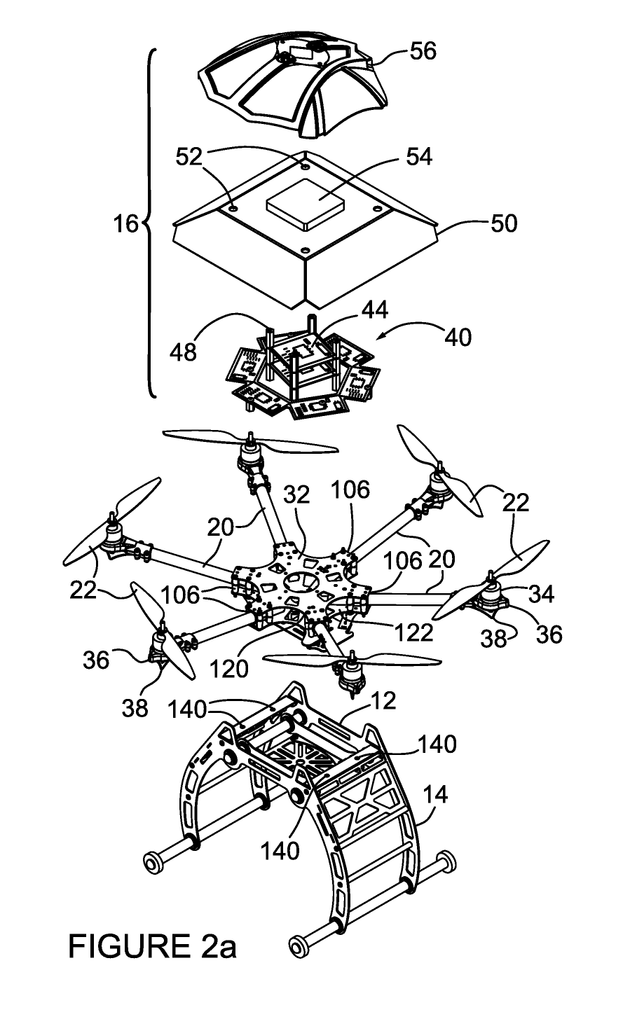

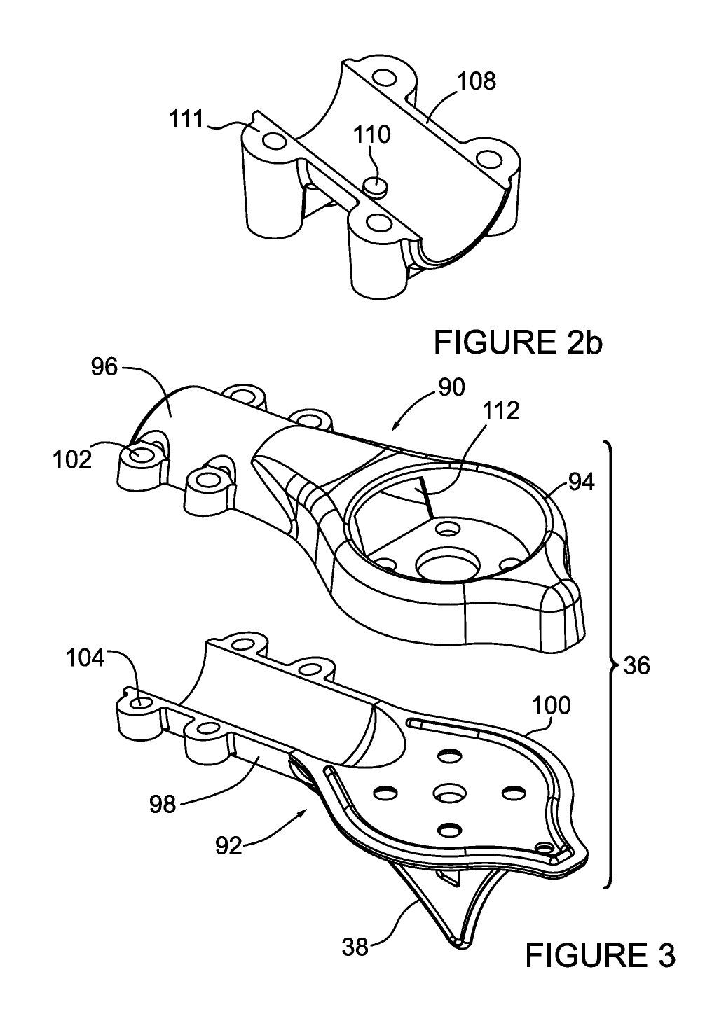

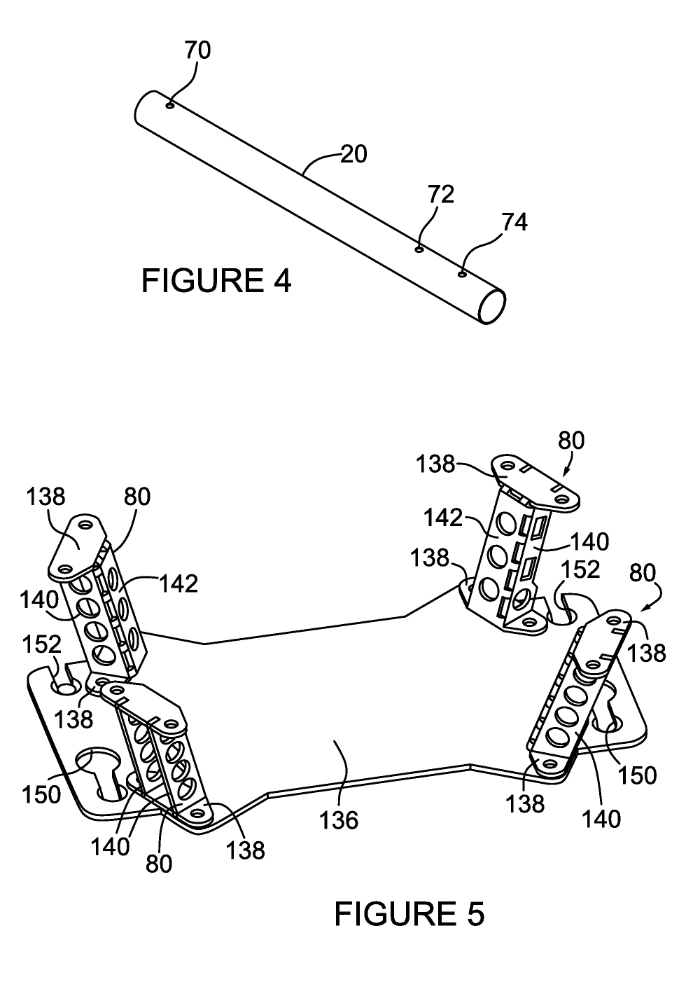

FIG. 2 shows an exploded view of the UAV of FIG. 1 which shows the six motor support arms 20 attached at their proximal ends to an associated motor support arm holders 106 arranged symmetrically around the periphery of motor arm hub 32. The motor support arms 20 are connected at their proximal ends to a hub or holder 32 and are at an angle with respect to the horizontal as can be seen in the side view of FIGS. 4 and 5. The present design has several unique features with the angled features of the motor support arms 20. Most small multirotor design have flat or straight out motor support arms attached to a center plate, in the range of 200 mm to 400 mm in length and cause stress on the bottom mounting plate when carrying loads, often rendering the structural strength weak, and most times touchy on the controls. Studies by the inventors have shown that since having a stable platform in flight is key for the present UAV, a design with the motor support arm holders 106 in hub 32 configured so that when the motor support arms 20 are inserted into the holder, they are angled upwards at an angle between 6 to 10 degrees, most preferably at a 8 degree angle upwards. This drops the entire machine relative to the propellers 22 by 1.75 inches, making the UAV 10 unit more “bottom heavy”, thus creating a pendulum effect, which gives greater stability compared to propeller arms which extend straight out from the housing. The 8 degree angle, while optimal, is not essential and the angle could range between 6 to 10 degrees and still provide better stability compared to arms extending out horizontally at 0 degrees.

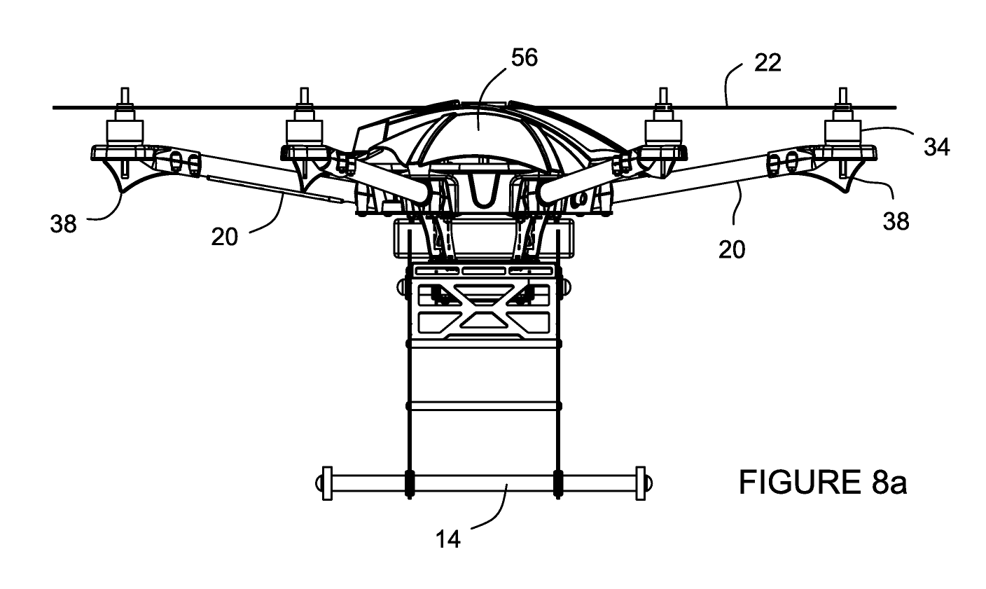

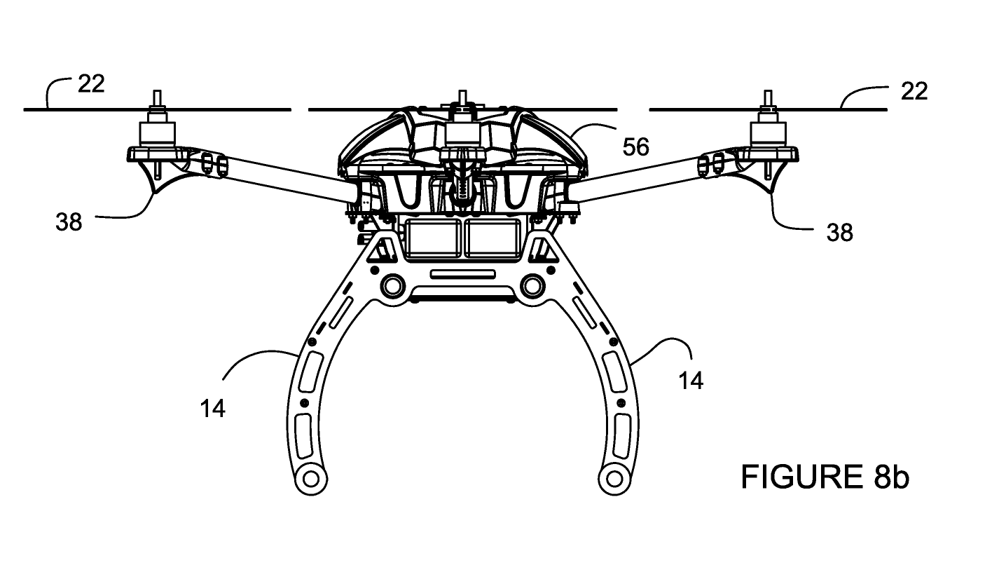

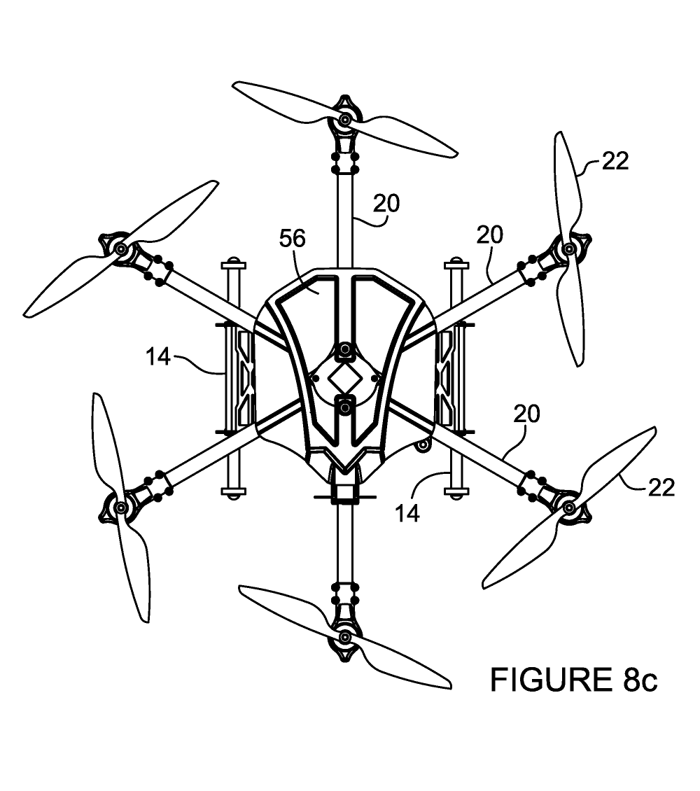

Another advantage of the motor support arms 20 being angled upwardly is that the distal ends of the motor support arms 20 are above a top surface of the canopy 56 such that in the event the unmanned aerial vehicle 10 is inverted upside down on the ground it rests on the propellers 22 and not on the top surface of the canopy 56, see FIGS. 8a and 8b.

Referring again to FIG. 2a, the proximal end of each motor arm 20 is clamped into hub 32 by way of the above-mentioned motor arm clamp 106 which is mounted and secured between top center plate 120 and bottom plate 122 of hub 32. Referring to FIG. 2b, one half of this motor arm clamp 106 is shown at 108. Clamp section 108 along with the other half of the motor arm clamp (not shown) are assembled around the proximal end of motor arm 20 and bolted closed around arm 20 and to top and bottom center plates 120 and 122 through bolt holes 111 in section 108 and corresponding bolt holes in the other half of clamp 106. in order to eliminate the risk of twisting or rotating on the arm 20, a small stub or knob 110 is secured on the inside of clamp section 108 which is small enough to extend through holes 72 and 74 located in arm 20, (see FIG. 4) depending on whether the motor arms 20 are fully extended or fully retracted. This configuration prevents arms 20 from twisting within motor clamp 106. Motor arm clamp 106 is angled between top and bottom center plates 120 and 122 to give the desired angle of motor arms 20 between 6 to 10 degrees.

Hub 32 is secured to support platform 12 when the UAV 10 is assembled. Utility housing 16 includes a circuit array 40 which includes all the various circuit boards required for operation of the UAV including such as balance controllers, motor controllers for controlling propeller motors 34, flight and navigation control board(s) and global positioning system (GPS) circuits, communication circuits to allow an operator on the ground to control all aspects of UAV 10. A GPS shield 50 is mounted over top of circuit array 40 and secured and hub 32 via holes 52 aligned with spacers 48 and aligned with corresponding holes located in hub 32. A GPS antenna 54 is mounted on top of GPS shield 50 which is connected to the GPS circuits located in circuit array 40. A cover dome or canopy 56 is secured to the above-mentioned holes in top center plate 120 in hub 32 by bolts extending through holes 52 and spacers 48. In an alternative embodiment canopy 56 may be attached directly to top center plate 120 of hub 32 by means of legs used specifically to attach the canopy 56 directly to the top center plate 120, in order to reduce vibration. The use of legs to connect the canopy 56 directly to the top center plate 120 is advantageous since there would be no contact between the canopy 56 and GPS shield 50, thereby reducing the chances of vibration. This would provide further protection for the various internal processor/circuitry and the hub 32.

FIG. 3 shows an exploded view of the motor holder 36, comprised of an upper section 90 and a lower section 92. Upper section 90 includes a clamping section 96 sized to sit around half the circumference of motor support arm 20 with section 96 being extended by a housing section 94 in which the propeller motor 34 (FIG. 2) is seated. Lower section 92 includes a clamping section 98 which is bolted to clamping section 96 of the upper section 94 around arm 20 through the bolt holes 102 and 104 in sections 90 and 92 respectively. Clamping section 98 is extended by a support section 100 onto which the motor housing section 94 is supported. In an embodiment, motor mount sections 90 and 92 are produced by an injection molding process using a special mix of Polypro, resin and glass to minimize expansion and shrinkage in variable weather conditions.

Referring to FIG. 4 again, each motor arm 20 include a hole 70 at its distal end which receives a stub (not shown) mounted on the inside of clamping section 96 (or 98) similar to stub 110 on clamp section 108 shown in FIG. 2b. When motor holder 36 is mounted onto the distal end of motor arm 20, this stub extends through hole 70 to lock motor holder 36 to arm 20 to prevent twisting of motor holder 36 with respect to arm 20. This configuration locks the clamping sections 96 and 98 in place holding arm 20 tight, and perfectly perpendicular for optimum flight performance. In other words the upper and lower motor mounts 90 and 92 respectively are designed such that, once attached to the arm 20, positions the propeller motor 34 horizontal flat and 90 degrees to the ground, making it parallel to the top and bottom center plates 120 and 122 respectively of the hub 32, seen in FIG. 2a. The upper section of the mount 90 and the lower section 92 are assembled together tightly around the distal end of motor support arm 20 and held together with bolts through holes aligned holes 102 and 104 which fix the propeller motor 34 to the motor holder 36.

Referring again to FIG. 3, the motor holders 36 have a square port 112 located on the inside, just below the propeller motor 34 (once installed) and lines up with the hollow interior of motor support arm 20 when mount sections 90 and 92 are clamped thereto. This feature is to force air from the prop wash, through the bottom inner portion of the motor holder 36, through the port 112, down the motor support arm 20 towards the hub 32 at the center of the UAV 10 where the electronic circuit array 40 is located, thus cooling the various electronic circuits including the balance controllers, the motor controllers, flight and navigation control board.

As can be more clearly seen in FIG. 3, lower section 92 of motor holder 36 has the small triangular fin 38 just below the motor area. As noted above, this fin serves as a stabilizer on the “yaw” axis (rotation of the unit left or right) which is useful in windy conditions for maintaining stability.

FIG. 4 shows the motor support arm 20 with three holes 70, 72 and 72. As noted above, hole 70 located at the distal end of motor support arm 20 that is used to lock arm 20 in position with respect to motor holder 36 by pin 110 (FIG. 2b) being inserted into hole 70 when motor support arm 20 is assembled with motor holder 36. In a non-limiting example, hollow motor support arm 20 may be made of aluminum alloy tubing at 208 mm long and 15.10 mm in diameter. Holes 72 and 74 located at the proximal end of hollow motor support arm 20 are for locking motor support arm 20 into its associated motor arm holder 106 (see FIG. 2a) in hub 32. The two (2) holes allows arm 20 to be locked in two (2) positions in holder 106 to give two different lengths of the motor support arms 20. As can be seen in FIG. 6, holes 72 are visible indicating the motor support arms 20 are locked into the hub 32 via holes 74 so that the arms are in their longest extension. The extension of the arms 20 can be shortened by unlocking the arms from the arm holder 80 and pushing in motor support arm 20 until hole 72 lines up with the holder 80 where upon it is locked in place to give a shorter extension of motor support arms 20 from the hub 32.

It will be understood that the UAV 10 may be produced with several motor support arms 20 of varying length with the same two (2) holes 72 and 72 so that UAVs with different length propeller arms may be configured. More than one motor support arm 20 is useful because with the limited interior dimensions of hub 32 only two extension lengths of motor support arms 20 by the two holes 72 and 74 are really feasible to maintain the structural integrity of the assembled UAV, thus multiple lengths of motor support arms 20 gives a wider range of propeller arm extension.

An advantage of this embodiment over UAV's that have telescoping motor arms is that telescoping motor arms are more prone to flexing, while the present design of multiple locking holes in the motor support arms 20 which allows them to be locked at different lengths with respect to hub 32 does not adversely affect the structural strength of the arm.

Conventional multirotor UAVs can have four (4), six (6), or eight (8) motor arms, made of a variety of materials, most of which are of fixed length while some designs have folding motor arms to collapse the UAV for storage. This type of design limits the size of props that can be used on the platform. In the present UAV 10, motor support arms 20 have an adjustable extension length relative to the hub to give greater choice for arm length.

Thus, UAV 10 may be sold disassembled in a kit form with four (4), six (6) or eight (8) motor support arms 20 and associated propeller motors 34 and motor holders 36. Each kit may include three support hubs 32, one configured with four holders 106, one with six (6) holders 106 and one with eight (8) holders 106 evenly distributed about the periphery of the associated hub 32. This allows the user/operator the flexibility to configure the UAV 10 depending on load to be carried, flight times etc.

UAV 10 shown in the Figures has six (6) rotors 22 with associated arms 20 and motors 34. It will be appreciated however that UAV's with tilted support arms 20 could be made with 4, 6 or 8 motor support arms 20. In this case the motor support arms 20, motor mounts 36 and the arm holders 106 would have the same design, with the only difference being the center plates 120 and 122 would be different to accommodate the different number of arms 20. Similarly, depending on the number of motors the circuit array 40 would change due to the different number of motors 36 being used and electronics associate with each motor 36.

An advantage of this design is that it allows the use of propellers of different diameter, for example, non-limiting examples include the option of 9″, 10′″, 11″ or 12″ propellers. When shorter motor support arms 20 are used then the smaller props would be used in conjunction therewith, so that it would carry less payload, and thus less stress on the propeller motors 34 and hence longer flight times. Conversely when longer motor support arms 20 are used for bigger propellers, the UAV 10 will be able to carry more payload but for less flight time.

FIG. 6 is a bottom perspective view of the propeller rotor hub 32, motor support arms 20 and propeller motors 34 assembled. As noted above hub 32 includes top center plate 120 and bottom center plate 122 bolted together. Bottom center plate 122 has small triangles 130 cut where the tip of the motor support arms 20 are received into the hub 32, which acts as a brace and renders structural strength which gives superior capability of handling more payload without flexing. The top center plate 120 acts as a brace, resisting the flex of the motor support arms 20 during flight. The arm holders 106 are sandwiched between these two center plates 120 and 122 and secured with bolts and lock nuts. This plate design combined with the angles advantageously allow up to 52 lbs of weight to be put on the six (6) motor support arms 20 before sustaining structural failure.

A current problem with the multirotor UAVs is how to supply enough power to the system in an efficient way and to allow for ease of a user in changing power packs and not throwing the center of gravity (CG) out. Most systems on the market today have to mount the batteries on the bottom of the UAV, which puts them in the way of camera mounts, in the front or rear, rendering the UAV unstable and gyros are constantly engaged to keep the flying platform level or on top, making the unit top heavy and creating a magnetic charge around the GPS system.

UAV 10 is provided with an adaptor plate 136, best seen in FIG. 6 which is configured to facilitate the rapid detachment of the landing gear assembly from the main UAV hub 32, thus provide a quick-detachable mount. This allows users/operators of the UAV 10 to have several landing gears with a multitude of equipment they wish to carry, but not have the time consuming task of unbolting and setting the equipment they plan to carry with the UHV 10 unit. The adapter plate 136 is provided with four (4) slots (there may be more or less but at least two (2)), including two (2) keyhole slots 150 formed in the body of plate 136 on one side and two slots 152 on the other side of the plate 136 which extend in from the edge of plate 136. Referring to FIG. 7, slots 150 are aligned with corresponding two holes 62 in the two plates 60 and slots 152 are aligned with the other two slots in the two plates 152 and bolted in place to attach the plate 136 and everything mounted above it to the landing gear assembly. Thus plate 136 easily slides off the landing gear by loosening the four (4) bolts. The slots 150 and 152 have beveled edges so as to lock in the screws once tightened. This prevents “sliding out” and dropping while in flight.

In an non-limiting embodiment, adaptor plate 136 is cut out of Phenolic G10 aerospace material, offering hard density, low static conductivity part and has grooves to insert belts, or Velcro straps and slots for inserting bolts, giving the user/operator of UAV 10 the options to attach a variety of accessories they may be using to adapter plate 136. A Hex tool is supplied with the kit which fits the screws that come with the base assembly.

Referring to FIG. 5, four (4) support bracket or leg assemblies shown generally at 80 are used to attach the universal adaptor plate 136 to bottom center plate 122 of hub 32 thereby creating a space between them that forms the battery compartment. Each leg assembly 80 includes two side plates 140 each attached along one side to a back plate 142. Plates 140 and 142 are attached at each end thereof to mounting plates 138 with one of the mounting plates 138 bolted to universal adapter plate 136 as shown in FIG. 5, and the mounting plate 138 located the other end being bolted to the bottom side of lower center plate 122 (see FIG. 6).

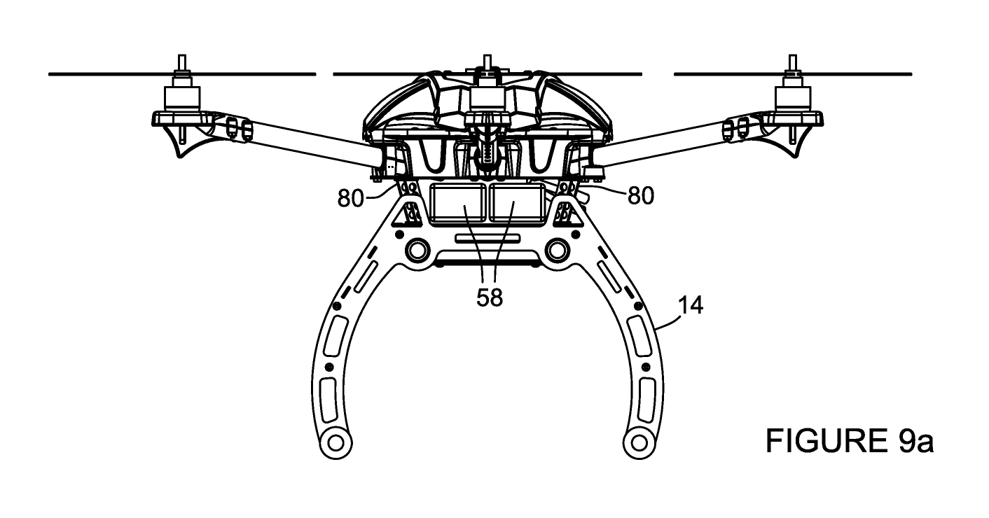

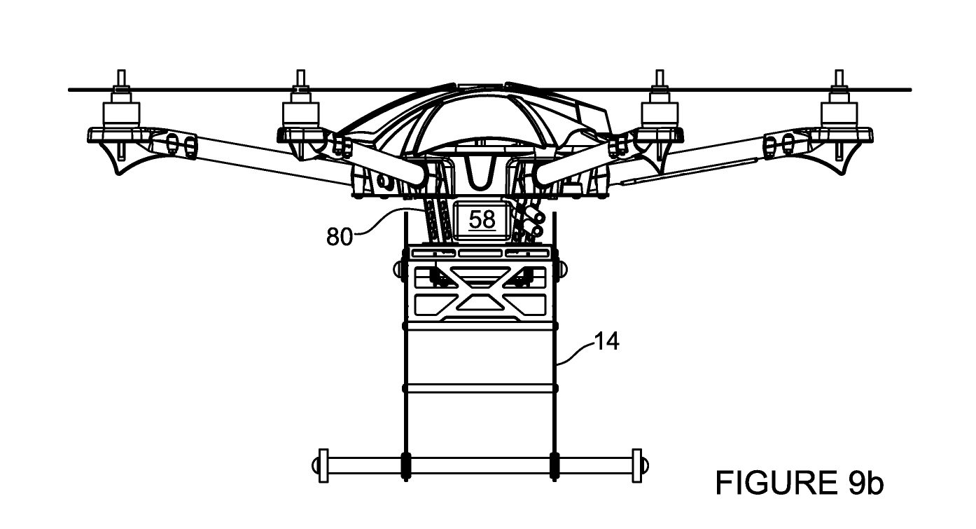

Those skilled in the art will appreciate that supplying power to all the various components, motors, circuits, sensors etc. puts a strain on the UAV battery. In the present system, referring again to FIG. 1 again, UAV 10 is configured to allow for the insertion of either one or two battery packs 58 to address this issue. The UAV 10 is designed so that universal adapter plate 136 is spaced below the lower plate 122 of the hub 32 a sufficient distance so that a volume is created that can hold one or two batteries 58 (FIG. 1). Referring to FIGS. 5, 9a and 9b it can be seen that because the universal adapter plate 136 is rectangular, by positioning the leg assemblies 80 at the corners of adapter plate 136 (which are located on opposed sides of UAV 10, this naturally produces a battery compartment in which two batteries 58 can be inserted from the front of UAV 10 (FIG. 9a) and only one battery 58 can be inserted from the side of UAV 10 between leg assemblies 80 (FIG. 9b).

Felt pads, (not shown) may be packed between the two batteries 58 (FIG. 9a) and between each battery and the leg assemblies on the outside of the batteries to ensure tight packing. Similar padding may be used between the single side loaded battery (FIG. 9b) and the four (4) leg assemblies 80 to ensure tight packing of battery 58. The felt pads, or other suitable type of packing material may be installed during production at the production facility, or if the UAV 10 is being shipped without the batteries 58 installed (such as in the event the user/operator wants to configure the UAV 10 for one or two batteries 58), then the user/operator may install the pads or other packing material.

These two battery storage configurations always centers the one (1) battery 58 when only one is used (FIG. 9b), and also centers the two (2) batteries 58 when they are front loaded into the volume on the platform 12 (FIG. 9a), thus not shifting weight in any direction. This relieves stress on the balance controllers and propeller motors 34, making the UAV 10 more stable and giving longer flight times.

While the Applicant's teachings described herein are in conjunction with various embodiments for illustrative purposes, it is not intended that the applicant's teachings be limited to such embodiments. On the contrary, the applicant's teachings described and illustrated herein encompass various alternatives, modifications, and equivalents, without departing from the embodiments, the general scope of which is defined in the appended claims.

Except to the extent necessary or inherent in the processes themselves, no particular order to steps or stages of methods or processes described in this disclosure is intended or implied. In many cases the order of process steps may be varied without changing the purpose, effect, or import of the methods described.

Therefore what is claimed is:

1. An unmanned aerial vehicle, comprising:
a) a landing gear including a support platform having opposed sides and a pair of landing gear legs descending from each of said opposed sides;
b) a housing and a support hub located therein;
c) a selected number of motor support arm holders evenly distributed about a periphery of said support hub;
d) each of said selected number of motor support arm holders having a proximal end portion of a corresponding motor support arm locked therein, said motor support arm holders being configured to lock the proximal end portion of the motor support arm such that the each motor support arm is inclined upwardly from horizontal by an angle in a range from about 6 to 10 degrees;
e) each motor support arm having a distal end and having a motor holder affixed thereto, and each motor holder having a propeller motor locked therein and each propeller motor having a propeller attached thereto;
f) an electronic control circuit array mounted on top of said top center plate;
g) a quick release universal utility plate releasably attached to, and spaced below, said bottom center plate, said quick release utility plate configured to releasably receive instrumentation for transportation by the unmanned aerial vehicle, said quick release universal utility plate being attached to said support platform;
h) said housing including a top canopy for enclosing and covering said electronic control circuit array and said hub which is releasably secured to said support platform; and
i) a space between said quick release utility plate and said bottom center plate configured to be a battery compartment and to receive therein one or two batteries electrically connected to said propeller motors and said electronic circuit array.

2. The unmanned aerial vehicle according to claim 1 wherein said support hub includes a top center plate and bottom center plate spaced apart and bolted together, and wherein said selected number of motor support arm holders evenly distributed about a periphery of said support hub are sandwiched between, and secured to, said top center plate and said bottom center plate.

3. The unmanned aerial vehicle according to claim 1 wherein each motor support arm is inclined upwardly from horizontal by an angle of about 8 degrees.

4. The unmanned aerial vehicle according to claim 1 wherein said motor support arms are hollow having a hollow interior, and wherein said motor holders include a port located below said propeller motor which is aligned with said hollow interior of said motor support arm so that air from propeller wash is forced through said port down said hollow interior into an interior of said support hub, and wherein said proximal ends of said motor support arms are positioned to direct said air towards said electronic circuit array for air cooling said electronic circuit array.

5. The unmanned aerial vehicle according to claim 1 wherein said motor holder includes a stabilizer fin extending below a bottom of said motor holder.

6. The unmanned aerial vehicle according to claim 5 wherein said stabilizer fin is generally triangular in shape and positioned on said bottom of said propeller motor holder so that air from the propeller wash is forced past said stabilizer fin 38 thereby acting to aid in stabilizing the unmanned aerial vehicle in flight.

7. The unmanned aerial vehicle according to claim 1 wherein said battery compartment is configured to receive one battery inserted from a side of said unmanned aerial vehicle with said one rectangular battery being centered in said battery compartment.

8. The unmanned aerial vehicle according to claim 1 wherein said battery compartment is configured to receive two batteries inserted from a front of said unmanned aerial vehicle with said two batteries being centered in said battery compartment.

9. The unmanned aerial vehicle according to claim 1 wherein said selected number of motor arm support holders is any one of four, (4), six (6), and eight (8), and including a corresponding number of support arms mounted symmetrically around the hub.

10. The unmanned aerial vehicle according to claim 1 wherein said motor support arm holders include a two (2) piece clamp including two (2) clamp sections, which upon being assembled together, between said top center plate and said bottom center plate, has an interior to receive therein said proximal end of said motor support arm, and upon being bolted together locks said motor support arm in place.

11. The unmanned aerial vehicle according to claim 1 wherein said motor support arm holders and associated motor support arms clamped therein include a locking mechanism configured to prevent rotation of the motor support arm with respect to said motor support arm holder.

12. The unmanned aerial vehicle according to claim 11 wherein said locking mechanism includes a stud located on an inner surface of at least one of said clamp sections, and said proximal end of said motor support arm clamped between said two clamp sections including a hole having a size sufficiently large to receive said stud therein.

13. The unmanned aerial vehicle according to claim 11 wherein said locking mechanism includes a stud located on the proximal end of said motor support arm and one of said two clamp sections including a hole having a size sufficiently large to receive said stud therein.

14. The unmanned aerial vehicle according to claim 1 wherein each motor holder includes a two (2) piece clamp including two (2) clamp sections, which upon being assembled together, has an interior to receive therein said distal end of said motor support arm, and upon being bolted together locks said motor holder to said motor arm, and wherein a top clamp section of said two clamp sections includes a receptacle to receive therein said propeller motor, and wherein a bottom clamp section of said two clamp sections includes a stabilizer fin integrally formed therewith on a bottom surface of said bottom clamp section.

15. The unmanned aerial vehicle according to claim 14 wherein said motor holder and associated distal end of said motor support arm clamped therein include a locking mechanism configured to prevent rotation of the motor holder with respect to said motor support arm.

16. The unmanned aerial vehicle according to claim 15 wherein said locking mechanism includes a stud located on an inner surface of at least one of said clamp sections, and said distal end of said motor support arm clamped between said two clamp sections including a hole having a size sufficiently large to receive said stud therein.

17. The unmanned aerial vehicle according to claim 15 wherein said locking mechanism includes a stud located on the distal end of said motor support arm and one of said two clamp sections including a hole having a size sufficiently large to receive said stud therein.

18. The unmanned aerial vehicle according to claim 1 wherein said motor arm holders and said motor support arms are configured such that each motor support arm is moveable in said motor arm holder between at least two positions and can be locked in each position to provide at least two pre-set lengths of the motor support arm with respect to the hub.

19. The unmanned aerial vehicle according to claim 18 wherein said motor arm holders include a two (2) piece clamp including two (2) clamp sections, which upon being assembled together, has an interior to receive therein said proximal end of said motor support arm, and upon being bolted together locks said motor arm in place.

20. The unmanned aerial vehicle according to claim 18 wherein said motor arm holders and associated motor support arms clamped therein include a locking mechanism configured to lock said motor support arms in said at least two positions with respect to said motor support arm holders, and to prevent rotation of the motor support arm with respect to said motor support arm holder when locked in each of said at least two positions.

21. The unmanned aerial vehicle according to claim 20 wherein said locking mechanism includes a stud located on an inner surface of at least one of said clamp sections, and said proximal end of said motor support arm clamped between said two clamp sections including at least two holes spaced apart having a size sufficiently large to receive said stud therein, and wherein in at least a first of said at least two positions said stud is inserted through a first hole of two holes, and in a second of said at least two positions said stud is inserted through a second hole of the two holes.

22. The unmanned aerial vehicle according to claim 20 wherein said locking mechanism includes at least two spaced studs located on the proximal end of said motor support arm and one of said two clamp sections including hole having a size sufficiently large to receive each stud therein.

23. The unmanned aerial vehicle according to claim 1 configured such that said distal end of said motor support arms are above a top surface of said canopy such that in the event said unmanned aerial vehicle is inverted upside down on the ground it rests on the propellers and not said top surface of said canopy thereby providing protection for said electronic array.

24. The unmanned aerial vehicle according to claim 1 wherein said selected number of motor arm support holders is six (6), and including a six (6) corresponding support arms mounted symmetrically around the hub.

25. The unmanned aerial vehicle according to claim 1 wherein said support platform includes a support plate mounted on spaced beams oriented at about 90 degrees to a planar surface of said support plate, each end of each of said spaced beams having a hole extending therethrough, including O-rings mounted in said holes, including a first and second tubes mounted on said support platform at opposed sides thereof with said tubes extending through corresponding ends of said spaced beams such that said support plate is slidable back and forth towards the front and back of said support platform such that when a load is attached to said support plate its center of gravity can be adjusted.

26. The unmanned aerial vehicle according to claim 1 wherein said quick release universal adapter plate includes a pair of spaced holes located at side edges of said utility plate, and wherein said support platform includes a pair of spaced plates located on the side edges of said support platform each having two spaced holes extending therethrough in registration with corresponding holes in said quick release utility plate which are used to attach said universal adapter plate to said support platform.

27. An unmanned aerial vehicle kit, comprising:
a) a landing gear including a support platform having opposed sides and a pair of landing gear legs descending from each of said opposed sides;
b) four (4), six (6) and eight (8) motor support arms;
c) support hubs for each of said four (4), six (6) and eight (8) motor support arms, each support hub including support arm holders evenly distributed about a periphery of said support hub;
d) each of said motor support arm holders having a proximal end portion of a corresponding motor support arm locked therein, said motor support arm holders being configured to lock the proximal end portion of the motor support arm such that the each motor support arm is inclined upwardly from horizontal by an angle in a range from about 6 to 10 degrees;
e) each motor support arm having a distal end and having a motor holder affixed thereto, and each motor holder having a propeller motor locked therein and each propeller motor having a propeller attached thereto;
f) an electronic control circuit array mounted on top of said top center plate;
g) a quick release universal plate releasably attached to, and spaced below, said bottom center plate, said quick release utility plate configured to releasably receive instrumentation for transportation by the unmanned aerial vehicle, said quick release universal plate being attached to said support platform;
h) a housing including a top canopy for enclosing and covering said electronic control circuit array and said hubs which is releasably secured to said support platform; and
i) a space between said quick release utility plate and said bottom center plate configured to be a battery compartment and to receive therein one or two batteries electrically connected to said propeller motors and said electronic circuit array.
